(19) United States
(12) Patent Application Publication
(10) Pub. No.: US 2026/0001243 A1
(43) Pub. Date: Jan. 1, 2026

(54) KNIFE WITH WIRE CLIP

(71) Applicant: Fiskars Brands, Inc., Middleton, WI (US)

(72) Inventor: Grant Bessac, Beaverton, OR (US)

(73) Assignee: Fiskars Brands, Inc., Middleton, WI (US)

(21) Appl. No.: 19/247,399

(22) Filed: Jun. 24, 2025

Related U.S. Application Data
(60) Provisional application No. 63/664,438, filed on Jun. 26, 2024.

(51) Int. Cl. B26B 1/10; A45F 5/02; B26B 1/04

(52) U.S. Cl. CPC B26B 1/10; A45F 5/022; B26B 1/048

(57) ABSTRACT

A knife includes a blade, a handle coupled to the blade, and a clip coupled to the handle at a plurality of attachment interfaces. The clip may be a wire clip which can be difficult to couple to a handle. The coupling at each of the plurality of attachment interfaces includes a through-hole in the handle, a clip hole in the handle intersecting the through-hole, a recessed slot in the handle extending from the clip hole, a clip end of the clip positioned at least partially within the clip hole and extending at least partially into the recessed slot, and a fastener removable positioned within the through-hole. The fastener may be a screw with threads configured to engage both the handle and the clip end to secure the clip to the handle and prevent twisting of the clip relative to the handle.

### CROSS-REFERENCE TO RELATED PATENT APPLICATIONS

This application claims the benefit of and priority to U.S. Provisional Patent Application No. 63/664,438, filed on Jun. 26, 2024, the entirety of which is incorporated herein by reference.

### TECHNICAL FIELD

The present disclosure relates generally to folding knives and in particular to attachment mechanisms for securely coupling wire pocket clips to the handles of folding knives.

### BACKGROUND

Folding knives often include clips, usually attached with screws, for carrying the knives securely in a pocket. To reduce weight, the clips may be made of wire, but it can be hard to securely attach a wire clip to the handle of the knife with a screw, especially in plastic or composite handles where screw holes may deform or strip. Wire clips in such circumstances are prone to rotate and move within their mounting holes relative to the handle. Threaded metal inserts allow for a more secure connection but add cost and labor. It would be beneficial to be able to securely attach wire clips to handles without the need for metal inserts.

### SUMMARY

One embodiment of the invention relates to a knife including a blade, a handle coupled to the blade, and a clip coupled to the handle at a plurality of attachment interfaces. The coupling at each of the plurality of attachment interfaces includes a through-hole in the handle, a clip hole in the handle intersecting the through-hole, a recessed slot in the handle extending from the clip hole, a clip end of the clip positioned at least partially within the clip hole and extending at least partially into the recessed slot, and a fastener removable positioned within the through-hole to engage both the handle and the clip end.

Another embodiment of the invention relates to a handle including a handle body and a wire clip coupled to the handle body at a plurality of attachment points. Each attachment point includes a through-hole in the handle body, a clip hole in the handle body at least partially overlapping the through-hole, a recessed slot at least partially overlapping the clip hole, an L-shaped clip end positioned at least partially within the clip hole and extending at least partially into the recessed slot, and a screw positioned within the through-hole to engage both the handle body and the clip.

Another embodiment of the invention relates to a method of assembling a handle. The method includes providing a handle including a plurality of attachment interfaces, wherein each of the plurality of attachment interfaces includes a through-hole in the handle, a clip hole intersecting the through-hole, and a recessed slot extending from the clip-hole. The method includes coupling a clip to the handle at the plurality of attachment interfaces, wherein coupling the clip to the handle at each attachment interface includes passing a clip end of the clip through the through-hole and the clip hole such that the clip end is at least partially within the clip hole and extends at least partially into the recessed slot and securing the clip end to the handle by engaging a screw into the through-hole.

### BRIEF DESCRIPTION OF THE FIGURES

The invention will become more fully understood from the following detailed description, taken in conjunction with the accompanying drawings, in which:

FIG. 1 is a perspective view of knife with a clip, according to an exemplary embodiment.

FIG. 2 is an exploded view of the knife of FIG. 1.

FIG. 3 is a right side view of a handle of the knife of FIG. 1.

FIG. 4 is a left side view of the handle of the knife of FIG. 1.

FIG. 5 is an enlarged view of the handle of the knife of FIG. 1.

FIG. 6 is a perspective view of a clip of the knife of FIG. 1.

FIG. 7 is a cross-section view of the knife of FIG. 1.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a wire clip attachment for a folding knife is disclosed. The knife includes a blade rotatably coupled to a handle. For example, the blade may rotate relative to the handle between a first position (e.g., an open position) and a second position (e.g., a closed position). The handle of the folding knife is removably coupled to a wire clip. The handle includes a plurality of attachment interfaces or attachment points where the clip is coupled to the handle. Each attachment interface or point includes a through-hole. The through-hole intersects another through hole referred to herein as a clip hole or a wire hole. Each through-hole is offset from the intersecting clip hole such that each intersecting pair of through-holes and clip holes form a continuous slot in the handle. Intersecting with each clip hole is a recessed slot on one side of the handle. There may be multiple attachment interfaces, such that there are multiple through-holes, clip holes, and recessed slots.

According to various exemplary embodiments, the clip includes a lever and a plurality of L-shaped clip ends, with each clip end including a stem and a hook. The stem is approximately perpendicular to the hook and the hook extends generally along the plane of the lever but in an opposite or substantially opposite direction. Each hook of the clip ends passes through a through-hole and clip hole pair beginning at the side of the knife opposite the recessed slots. The hook then extends into the recessed slot while the stem is positioned in the clip hole. A fastener such as a screw is threaded into the through-hole from the side of the knife including the recessed slots. According to various embodiments, the threads of the screw engage with both the handle and the stems of the clip ends to secure the clip to the handle. Beneficially because the threads engage with the wire clip itself, the clip is less prone to rotating relative to the handle. In various embodiments, the head of the screws at least partially overlaps with the hooks pushing the hooks down and into the recessed slots. This further secures the clip to the handle and helps to prevent the clip from moving relative to the handle.

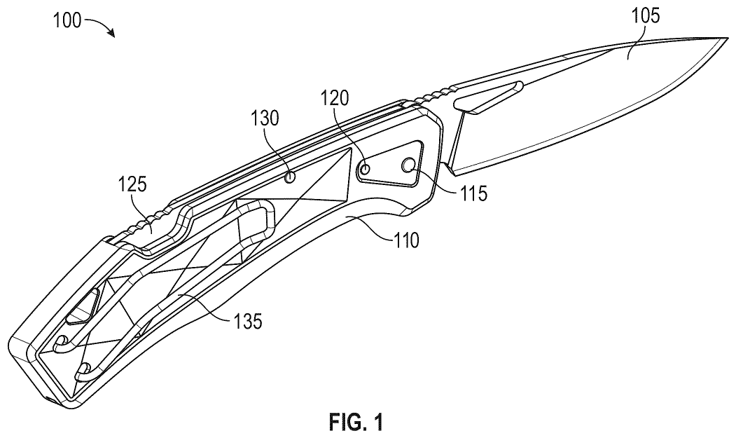

Referring now to FIG. 1, a perspective view of a knife 100 (e.g., a folding knife) in an open opposition is shown, according to an exemplary embodiment. The folding knife 100 includes a blade 105 and a handle 110. The handle 110 may be a single continuous part of made of multiple parts coupled together. In some embodiments, the handle 110 is injection molded. Still in other embodiments the handle 110 is machined, stamped, or otherwise formed. The blade 105 is rotatably coupled to the handle by pin 115. A stop pin 120 limits the rotation of the blade as it transitions from the open position to the closed position. As the blade 105 rotates from the open position to the closed position, the blade 105 engages with the stop pin 120 preventing the blade 105 from rotating further. In the closed position, the blade 105 is at least partially within the handle 110 of the knife 100. The knife 100 includes a locking assembly including a back rocker 125 configured to selectively secure the blade 105 at least partially within the handle 110 in the closed open as well as in the open position. The back rocker 125 is rotatably coupled to the handle 110 by a rocker pin 130. For example, when the knife 100 is in the first orientation (e.g., the closed orientation), the back rocker 125 may secure the blade 105 within the handle 110 to prevent inadvertent opening of the knife 100. The back rocker 125 may then be manipulated by a user of the knife 100 to unlock the blade 105 such that the blade 105 may be rotated outside of the handle 110 (e.g., by applying a force to the blade 105) into a second position (e.g., an opened position) and thereafter secured by the back rocker 125, as shown in FIG. 1.

Referring still to FIG. 1, the knife 100 includes a clip 135 removably coupled to the knife 100. The clip 135 is made of a continuous length of wire bent into the shape of a clip. The wire is made of metal such that the clip 135 is elastic and can reversibly deform to accommodate being pushed over a piece of clothing or other attachment surface. In some embodiments, the clip 135 is made of other materials able to elastically deform such as plastic, carbon fiber, etc. In some embodiments, the clip 135 is only partially constructed of wire. For example. The clip 135 may include a plate section and a wire section. In such embodiments, the plate section may be used as the lever of the clip 135 while the wire section couples the clip 135 to the handle 110. In some embodiments, the plate section and the clip section are made of the same materials or of different materials.

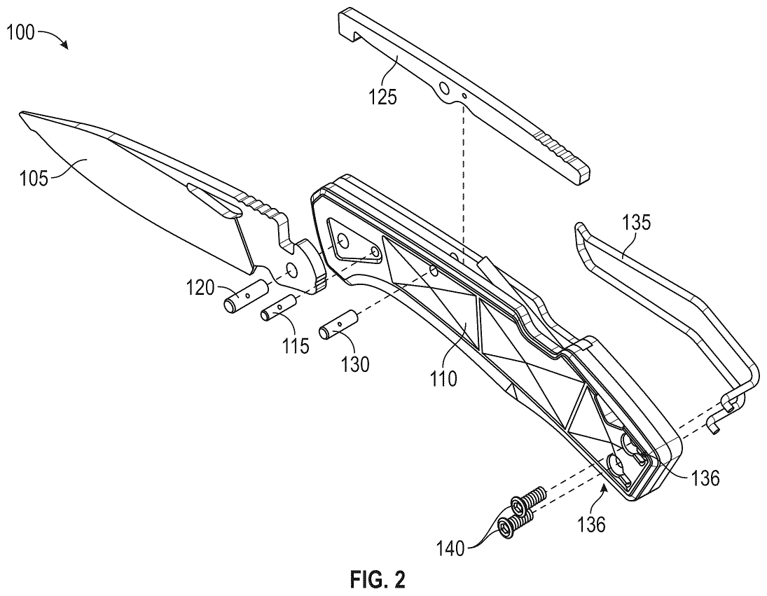

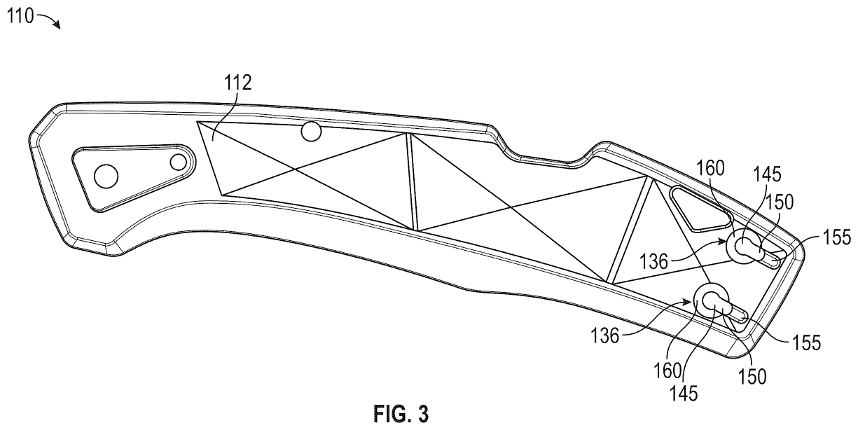

Referring now to FIG. 2, an exploded view of the knife 100 of FIG. 1 is shown, according to an exemplary embodiment. As shown, the handle comprises two attachment interfaces 136. The ends of the clip 135 pass through the handle 110 at the attachment interfaces 136 and the clip 135 is coupled to the handle 110 by a plurality of fasteners shown as screws 140 at the attachment interfaces 136. The engagement between the clip 135 and the handle 110 at the attachment interfaces 136 is explained in further detail below with regards to FIGS. 3-5 and 7.

Referring now to FIGS. 3-5, the handle 110 is shown, according to an exemplary embodiment. The handle 110 includes a plurality of attachment interfaces 136. Each of the plurality of attachment interfaces 136 includes a through-hole 145 extending through a first side 112 of the handle 110 to a second side 114 of the handle 110. The through-holes 145 are positioned proximate an end of the handle 110 opposite the end of the handle 110 coupled to the blade 105. The through-holes 145 extend entirely through the handle 110. While two through-holes 145 are shown, it should be understood that in some embodiments there may be more or fewer attachment interfaces 136 and thereby more or fewer through-holes 145. The attachment interfaces 136 are also shown to each include a clip hole 150. Each clip hole 150 intersects a through-hole 145 of the respective attachment interface 136 forming an intersecting pair. The intersecting pair forms a continuous slot through the handle 110 in each attachment interface 136. The centers of each clip hole 150 and through-hole 145 are aligned such that the through-hole 145 and clip hole 150 intersecting pair are symmetrical across a center axis. In some embodiments, a diameter of the clip hole 150 is less than or equal to a diameter of the through-hole 145. In some embodiments, the clip hole 150 is an elongated slot with a length greater than a diameter of the clip hole 150.

Referring specifically to FIG. 3, each attachment interface 136 of the handle 110 includes a recessed slot 155 in the first side 112 of the handle 110. The recessed slot 155 is shown with the same diameter as the clip hole 150. Each recessed slot 155 intersects and extends from a clip hole 150 of the respective attachment interface 136. The recessed slots 155 extends partially into the handle 110 with a depth that may be equal to or greater than a diameter of the clip 135.

In some embodiments, one or more of the attachment interfaces 136 or elements thereof such as the through-holes 145, the clip holes 150, and the recessed slots 155 are formed integrally in the handle during an injection molding process. In other embodiments, the handle 110 is formed in an additive manufacturing process and one or more of the attachment interfaces 136 or elements thereof such as the through-holes 145, the clip holes 150, and the recessed slots 155 are formed as a part of that process. Still in other embodiments one or more of the attachment interfaces 136 or elements thereof such as the through-holes 145, the clip holes 150, and the recessed slots 155 are machined into the handle 110.

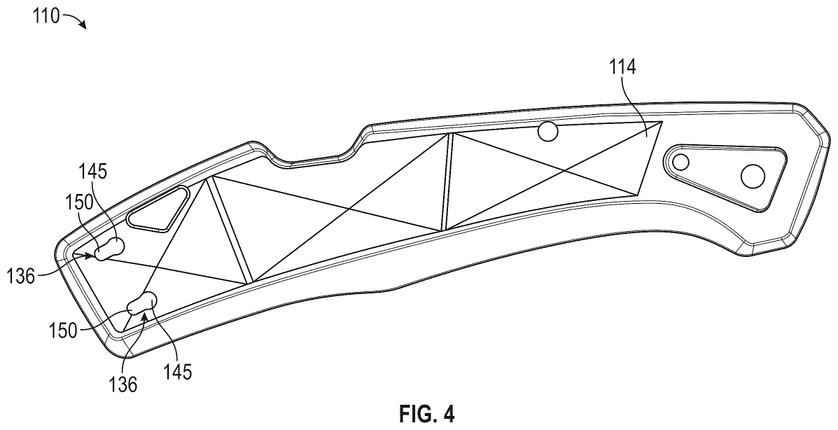

Referring specifically to FIG. 4, the through-holes 145 and the clip holes 150 of each attachment interface 136 are shown extending through the handle 110 and out the second side 114 of the handle 110. As shown, the intersecting pairs of through-holes 145 and clip holes 150 form a key-way shaped cutout or aperture through the handle 110.

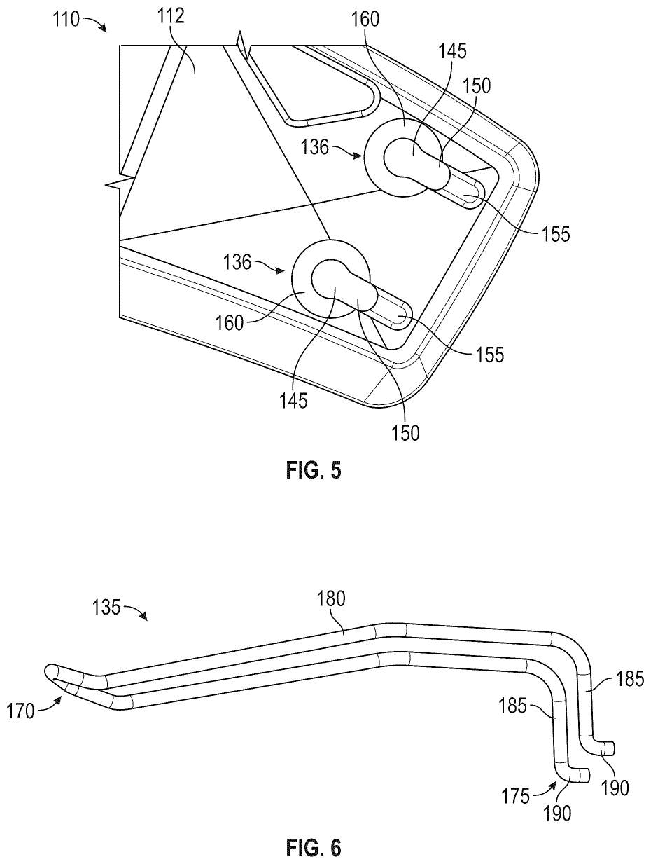

As shown in FIGS. 3 and 5, on a first side 112 of the handle 110 the through-holes 145 include countersinks 160. The countersinks 160 allow a head of the screws 140 to rest at or below the surface of the first side 112 of the handle 110. As explained in further detail below, this allows the heads of the screws 140 to engage with and press the ends of the clip 135 into the recessed slots 155, thereby further securing the clip 135 to the handle 110.

Referring now to FIG. 6, a perspective view of the clip 135 is shown, according to an exemplary embodiment. The clip 135 includes a first end 170 and a second end or clip end 175. Between the first end 170 and the second end 175 is a lever section 180. The lever section 180 may elastically deform and allow the clip to engage with one or more attachment surfaces (e.g., a pocket) to secure the knife 100 to the pocket. As shown, the clip end 175 is L-shaped and includes a two stems 185 and two hooks 190. Each hook 190 is approximately perpendicular to each stem 185 and extends along a general plane of the lever section 180, but in an opposite or substantially opposite direction. The stems 185 may have a length equal to or greater than the thickness of the handle 110 such that there may be a gap between the lever 180 and the handle 110 when the clip 135 is coupled to the handle 110. The stems 185 may elastically deform in addition to or alternatively to the lever section 180 and allow the clip to engage with one or more attachment surfaces (e.g., a pocket) to secure the knife 100 to the pocket. While clip 135 is shown as a continuous piece of wire, it should be understood that the clip 135 may be made of a plate coupled to two clip ends 175. In other embodiments, the clip 135 may be made of two or more discrete pieces of wire coupled together.

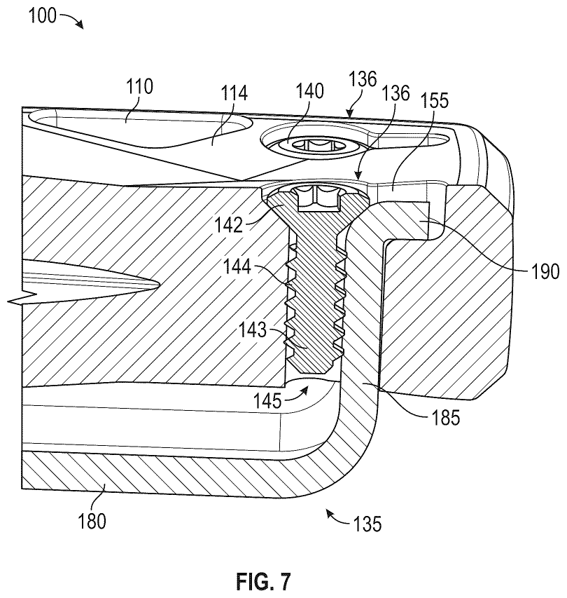

Referring now to FIG. 7, a cross-section of the knife 100 is shown, according to an exemplary embodiment. As shown, the clip 135 is coupled to the handle 110 at attachment interfaces 136 by screws 140. To couple the clip 135 to the handle 110 at attachment interfaces 136, first each hook 190 and stem 185 of the clip 135 is passed into the intersecting pair of through-holes 145 and clip holes 150 of each attachment interface 136. A length of the hook 190 is less than a length of each intersecting pair of through-holes 145 and clip holes 150 such that the hook 190 can pass through the handle 110 after the hook 190 is already formed in the clip 135. In other embodiments, the clip 135 is passed through the intersecting pair of through-holes 145 and clip holes 150 with the stem 185 but prior to the hooks 190 being formed. The hooks 190 are therefore formed after the stem is passed through the handle 110.

After passing the hook 190 and the stem 185 through the intersecting pair of through-holes 145 and clip holes 150, each hook 190 is positioned in a respective one of the plurality of recessed slots 155 of the attachment interfaces 136. As shown, the recessed slot 155 may have a depth greater than a diameter of the hook 190, such that the hook 190 is positioned at or below a surface of second side 114 of the handle 110. The stem 185 extends through the knife and is positioned at least partially in each respective clip hole 150. The lever section 180 is positioned on the side of the knife 100 opposite each hook 190.

The clip 135 is thereafter removably coupled to the handle 110 at attachment interfaces 136 by the screws 140. Still referring to FIG. 7, the screw 140 includes a head 142, a shaft 143, and threads 144 extending at least partially along the shaft 143. In some embodiments, a diameter of the through-hole 145 is less than a diameter of the threads 144 such that the screw 140 threadably engages with the handle 110. For example, the screw 140 may be a self-tapping screw with the threads 144 cutting corresponding threads into the handle 110. In some embodiments, the threads 144 of the screw 140 also engage with the stem 185. For example, the threads 144 may cut corresponding threads into the stem 185 similar to how the threads 144 engage with the handle 110. In such embodiments, the screw 140 secures the clip 135 relative to the handle 110 and prevents movement of the clip 135 relative to the handle. Beneficially, as the screw 140 engages with the clip 135, especially when the clip 135 is made of metal, the clip 135 acts at least partially as a threaded metal insert. The metal-on-metal engagement helps to secure the clip 135 in place better than compared to the screw 140 engaging with the handle 110 alone. Similar benefits can be obtained when the clip 135 is made of other materials harder than the handle 110.

Still referring to FIG. 7, the head 142 of the screw is positioned in the countersink 160 of the attachment interfaces 136, thereby allowing the head 142 to engage at least partially with the hook 190. The head 142 applies a force down into the handle 110 on the hook 190. This force secures each hook 190 in its respective recessed slot 155. Thus secured, each recessed slot 155 prevents each hook 190 from rotating relative to the handle 110.

As utilized herein, the terms “approximately,” “about,” “substantially”, and similar terms are intended to have a broad meaning in harmony with the common and accepted usage by those of ordinary skill in the art to which the subject matter of this disclosure pertains, and mean +/−10% from the given value or direction. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the knife 100, the handle 110, and the clip 135 as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

What is claimed is:

1. A knife, comprising:
a blade;
a handle coupled to the blade; and
a clip coupled to the handle at a plurality of attachment interfaces, wherein the coupling at each of the plurality of attachment interfaces comprises:
a through-hole in the handle;
a clip hole in the handle intersecting the through-hole;
a recessed slot in the handle extending from the clip hole;
a clip end of the clip positioned at least partially within the clip hole and extending at least partially into the recessed slot; and
a fastener removably positioned within the through-hole to engage both the handle and the clip end.

2. The knife of claim 1, wherein the clip is comprised of wire with a diameter less than a diameter of the clip hole.

3. The knife of claim 1, wherein the clip end is L-shaped and comprises a stem and a hook, wherein the through-hole and corresponding intersecting clip hole have a first length, and wherein a second length of the hook is less than the first length.

4. The knife of claim 1, wherein the clip end is L-shaped and comprises a stem and a hook, and wherein the stem is positioned at least partially in the clip hole and the hook extends at least partially into the recessed slot.

5. The knife of claim 1, wherein the handle further comprises a first side and a second side and at least one of the plurality of attachment interfaces the through-hole extends from the first side to the second side.

6. The knife of claim 5, wherein at the at least one of the plurality of attachment interfaces the clip hole extends from the first side to the second side.

7. The knife of claim 1, wherein at least one of the plurality of attachment interfaces the clip end extends at least partially into the through-hole.

8. The knife of claim 1, wherein the fastener is a screw and the screw comprises threads and wherein the threads engage both the handle and the clip end.

9. The knife of a claim 1, wherein an end of the through-hole adjacent the recessed slot is countersunk.

10. The knife of claim 9, wherein the fastener comprises a head configured to engage the clip end and extend at least partially into the countersunk end.

11. A handle, comprising:
a handle body; and
a wire clip coupled to the handle body at a plurality of attachment points, each attachment point comprising:
a through-hole in the handle body;
a clip hole in the handle body at least partially overlapping the through-hole;
a recessed slot at least partially overlapping the clip hole;
an L-shaped clip end positioned at least partially within the clip hole and extending at least partially into the recessed slot; and
a screw positioned within the through-hole to engage both the handle body and the clip.

12. The handle of claim 11, wherein the L-shaped clip end comprises a stem and a hook, and wherein the clip end passes through the through-hole and the clip hole and into a installed position at least partially into the recessed slot.

13. The handle of claim 11, wherein the clip end extends at least partially into the through-hole.

14. The handle of claim 11, wherein the handle body further comprises a first side and a second side opposite the first side, the through-hole extending from the first side to the second side.

15. The handle of claim 14, wherein the clip further comprises a lever proximate the first side and wherein the clip end is positioned proximate the second side opposite the first side.

16. The handle of claim 15, wherein the screw extends into the through-hole from the second side.

17. The handle of claim 15, wherein the recessed slot is positioned in the second side.

18. A method of assembling a handle, comprising:
providing a handle comprising a plurality of attachment interfaces, wherein each of the plurality of attachment interfaces comprises;
a through-hole in the handle;
a clip-hole intersecting the through-hole; and
a recessed slot extending from the clip-hole; and
coupling a clip to the handle at the plurality of attachment interfaces, wherein coupling the clip to the handle at each of the attachment interfaces comprises:
passing a clip end of the clip through the through-hole and the clip hole such that the clip end is at least partially within the clip hole and extends at least partially into the recessed slot; and
securing the clip end to the handle by engaging a screw into the through-hole.

19. The method of claim 18, wherein threads of the screw engage both the handle and the clip and wherein a head of the screw engages the clip.

20. The method of claim 18, wherein the clip is comprised of wire with a diameter less than a diameter of the clip hole.
